(19) United States
(12) Patent Application Publication
(10) Pub. No.: US 2014/0292077 A1
(43) Pub. Date: Oct. 2, 2014

(54) METHOD FOR OPERATING AN ENERGY SUPPLY UNIT FOR A MOTOR VEHICLE ELECTRICAL SYSTEM

(71) Applicant: Julian ROESNER, Untergruppenbach (DE)

(72) Inventor: Julian ROESNER, Untergruppenbach (DE)

(73) Assignee: ROBERT BOSCH GMBH, Stuttgart (DE)

(21) Appl. No.: 14/224,327

(22) Filed: Mar. 25, 2014

(30) Foreign Application Priority Data
Mar. 27, 2013 (DE) 10 2013 205 413.0

(51) Int. Cl. B60R 16/03

(52) U.S. Cl. CPC B60R 16/03
USPC 307/10.1

(57) ABSTRACT

A method for operating an energy supply unit for a motor vehicle electrical system including at least one first subsystem and one second subsystem having different voltage levels, one first stator winding of an electric machine being connected via one first converter circuit to the first subsystem, and one second stator winding of the electric machine being connected via one second converter circuit to the second subsystem, and a DC-DC conversion taking place between the first subsystem and the second subsystem, while one of the converter circuits Is operated as an inverter and the other of the converter circuits is operated as a rectifier, and the first stator winding and the second stator winding are operated as a transformer.

### RELATED APPLICATION INFORMATION

The present application claims priority to and the benefit of German patent application no. 10 2013 205 413.0, which was filed in Germany on Mar. 27, 2013, the disclosure of which is incorporated herein by reference.

### FIELD OF THE INVENTION

The present invention relates to a method for operating an energy supply unit for a motor vehicle electrical system, including at least one first subsystem and one second subsystem having different voltage levels.

### BACKGROUND INFORMATION

Motor vehicle electrical systems may be configured as so-called two-voltage or multi-voltage vehicle electrical systems including at least two subsystems. Such electrical systems are used, for example, when consumers having different power requirements exist in a particular motor vehicle. In this case, at least two of the subsystems have different voltage levels, for example, 14 V (a so-called low-voltage subsystem) and 48 V (a so-called high-voltage subsystem). The subsystems may be connected to each other, for example via a DC-DC converter. At least one of the subsystems has a generator system that feeds the subsystem. A second or additional subsystem connected via the mentioned DC-DC converter may then in turn be supplied from the subsystem having the generator system.

Electric machines may be used, in particular, in hybrid vehicles in order to be motor operated as well as generator operated. The internal combustion engine may be assisted by a motor operation of the electric machine at low rotational speeds at which the former does not yet deliver its full torque. Upon deceleration of the motor vehicle, kinetic energy may then be converted into electrical energy by the generator operation of the electric machine.

During generator operation, the electric machine generates, if necessary, a polyphase current which may be rectified for a motor vehicle electrical system. To enable both motor operation as well as generator operation of the electric machine, the electric machine may be equipped with an inverter circuit which may be composed, for example, of electrical switches, for example, in the form of MOSFETs, an associated control circuit and an intermediate capacitance. To ensure high performances in both motor as well as generator operation of the electric machine, the electric machine may be operated with, or it may supply, the comparatively high, first voltage of the high voltage subsystem.

However, the use of both an inverter circuit and a DC-DC converter in this configuration is cumbersome and is associated with high costs. Moreover, the separate circuits of the inverter circuit and the DC-DC converter put a strain on the already severely limited installation space in a motor vehicle.

It is therefore desirable to provide a simple, cost-efficient and space-saving option for enabling both a generator as well as a motor operation of an electric machine in conjunction with different subsystems of the motor vehicle electrical system.

### SUMMARY OF THE INVENTION

The present invention provides a method for operating an energy supply unit for a motor vehicle electrical system having the features described herein. Advantageous embodiments are the subject matter of the further descriptions as well as the following description.

According to the present invention an electric machine of the energy supply unit includes two stator windings, each of which are connected via a converter circuit to one subsystem of the motor vehicle electrical system. The converter circuits may, for example, include half bridges with switches, in particular, MOSFETs. In particular, each of the converter circuits is configured analogously to a conventional inverter circuit.

According to the present invention the converter circuits are activated in such a way that the energy supply unit functions as a DC-DC converter and the stator windings as a transformer between the two subsystems. Depending on the need, one of the two converter circuits in this configuration is activated as an inverter in order to convert the subsystem d.c. voltage of the corresponding subsystem into an a.c. voltage. This a.c. voltage generates a current flow in the one associated stator winding of the two stator windings, which in turn induces an a.c. voltage in the other of the two stator windings. The other of the two converter circuits is actuated as a rectifier in order to rectify this induced a.c. voltage and feed it into the other subsystem.

According to the present invention, no additional separate DC-DC converter is required; the already existing parts and components of the converter circuits are used for rectification, inversion and transformation, thereby ultimately enabling a DC-DC conversion. Accordingly, the DC-DC conversion in terms of the present invention takes place via the same parts which are used for rectification and inversion and via the first and second stator winding. Thus, the method according to the present invention combines the advantages and functions of an inverter circuit and a DC-DC converter in one single circuit.

Therefore, no additional components and parts are required and the costs may be reduced. The stator winding is merely doubled, which is easy to implement and at no major expense. Compared to a conventional electric machine which has only one stator winding, the stator winding already existing in this case may either be split or an additional stator winding may also be integrated. The costs of integration and space requirements are also reduced. A processing unit used for actuating, including, for example, a microcontroller, may be used for controlling the rectification and the inversion as well as for controlling the transformation.

The present invention is particularly suited for electric machines, for example, a separately excited synchronous machine for use in motor vehicles. The principle may be employed in connection with a boost recuperation system (BRS) in the electric machine (boost recuperation machine).

By way of example, the first subsystem is assumed in the following to be a high voltage-vehicle electrical system which is operated with a first subsystem d.c. voltage, and the second subsystem is assumed to be a low voltage-vehicle electrical system which is operated with a second subsystem d.c. voltage, the first subsystem d.c. voltage having a higher voltage value than the second subsystem d.c. voltage.

Depending on the need, the first subsystem d.c. voltage of the first subsystem is converted downwards and transferred into the second subsystem, or the second subsystem d.c. voltage of the second subsystem is converted upwards and transferred into the first subsystem.

The first and second converter circuits may each also be activated as a step-down converter and/or as a step-up converter. In this way, the voltage value of the subsystem d.c. voltages of the two subsystems may be flexibly adjusted independently of one another. Alternatively or in addition, these voltage values may also be adjusted using a specific winding ratio of the first and of the second stator winding. The winding ratio may be oriented to the ratio of the two d.c. voltages, similarly to a conventional transformer. For example, a first d.c. voltage value of 48 V and a second d.c. voltage value of 12 V result in a winding ratio of 4:1.

By activating the two converter circuits, the deviations of the two subsystem d.c. voltages are compensated by nominal values which occur, for example, during varying states of charge of the battery. It is also advantageously feasible to use two identical stator windings and to implement a downward conversion of the first subsystem d.c. voltage completely by a step-down converter operation of the first converter circuit. This is useful, in particular, when a conventional electric machine having as few configuration changes as possible is intended to be used for a method according to the present invention.

The electric machine is advantageously operated in a second operating mode as a generator. In this mode, an in particular multiphase current, or an in particular multiphase output voltage provided by the electric machine is rectified by the converter circuits. Electrical power may be transferred in the second operating mode by the electric machine into the first and/or the second subsystem. The electrical powers transferred into the first and the second subsystem may be adjusted separately from one another by activating the two converter circuits. Thus, for example, a desired braking torque may be set in the first motor vehicle electrical system, while in the second motor vehicle electrical system a desired battery voltage may be regulated. In addition, this enables the electric machine to transfer electrical power directly into the first as well as into the second motor vehicle electrical system. This is particularly advantageous during an emergency operation of the generator in the event of a battery failure.

The electric machine may be operated in a third operating mode as a motor. In this case, the subsystem d.c. voltage of one of the subsystems is inverted by the converter circuits. Electrical power is advantageously transferred in such a case by the subsystem into the electric machine. The electric machine is supplied from one of the subsystems, in particular from the subsystem which is configured as a high voltage-vehicle electrical system having the higher subsystem d.c. voltage. The first subsystem is assumed to be the same, for example. Electrical power from the first subsystem is converted into mechanical power for driving the motor vehicle. The level of this mechanical power is adjusted via activation of the first converter circuit.

The second converter circuit is activated so that no power is transferred into the second subsystem. The second converter circuit may advantageously also be activated in such a way that during motor operation electrical power is transferred from the first motor vehicle electrical system into both the electric machine as well as into the second subsystem.

In one advantageous embodiment of the present invention, the second converter circuit is connectable, via a switch element, for example, to either the second subsystem or to the first subsystem. If the second converter circuit is connected to the first subsystem, the second stator winding may then also be used for transferring electrical energy between the first motor vehicle electrical system and the electric machine. During motor and generator operation, a maximum transferrable electrical power may then be transferred, respectively, between the first motor vehicle electrical system and the electric machine.

If the second converter circuit is connected to the second motor vehicle electrical system, the maximum transferrable electrical power may no longer be transferred between the first motor vehicle electrical system and the electric machine; instead, additional electrical power may be transferred into the second motor vehicle electrical system.

A processing unit according to the present invention, for example, a control unit of a motor vehicle, is programmed, in particular, to carry out a method according to the present invention.

The implementation of the method in the form of software is also advantageous, since this entails particularly low costs, in particular if a performing control unit is also used for other tasks and is therefore present anyway. Suitable data media for providing the computer program are, in particular, diskettes, hard-disk drives, flash memories, EEPROMs, CD-ROMs, DVDs and the like. It is also possible to download a program from computer networks (Internet, Intranet etc.).

Further advantages and embodiments of the present invention result from the description and the appended drawing.

It is understood that the features cited above and those to be explained below are applicable not only in each specified combination, but also in other combinations or alone, without departing from the scope of the present invention.

The present invention is schematically represented in the drawing based on exemplary embodiments and is described in greater detail below with reference to the drawings.

### BRIEF DESCRIPTION OF THE DRAWINGS

FIG. 1 schematically shows one specific embodiment of a multi-voltage vehicle electrical system having an energy supply unit according to the related art.

FIG. 2 shows one specific embodiment of a multi-voltage vehicle electrical system having an energy supply unit which is configured to carry out one specific embodiment of a method according to the present invention.

FIG. 3 shows in circuit diagram-like manner one specific embodiment of an energy supply unit which is configured to carry out one specific embodiment of a method according to the present invention.

FIG. 4 shows in a circuit diagram-like manner another specific embodiment of an energy supply unit which is configured to carry out another specific embodiment of a method according to the present invention.

### DETAILED DESCRIPTION

Corresponding elements are denoted by identical reference numerals. For the sake of clarity, these will not be repeatedly explained.

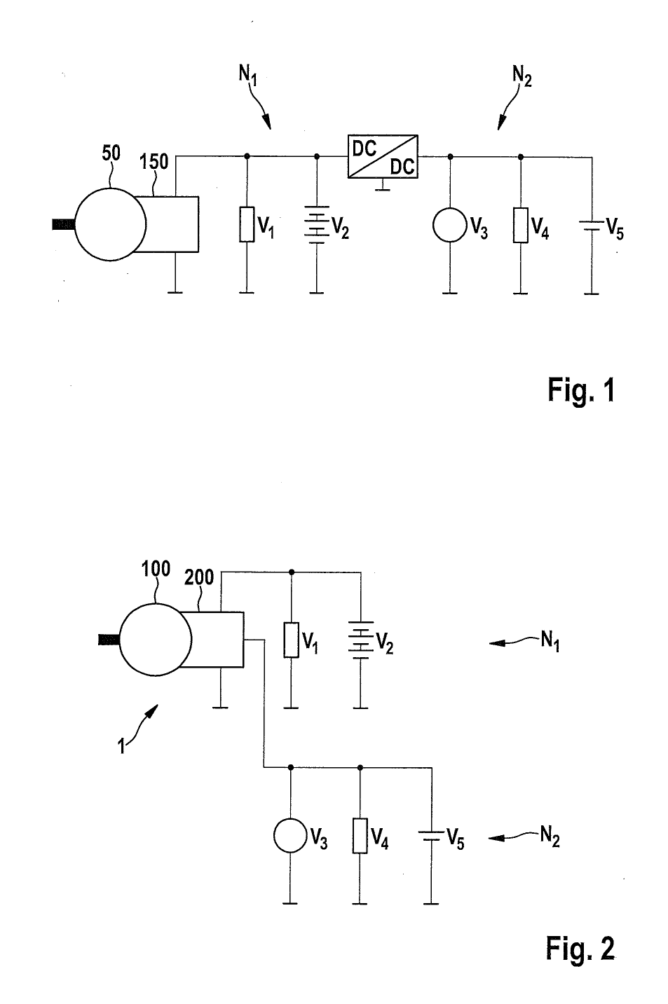

FIG. 1 schematically shows one specific embodiment of a multi-voltage vehicle electrical system having an energy supply unit of a motor vehicle electrical system according to the related art. In this example, the motor vehicle is configured as a hybrid vehicle. Connected downstream from a conventional electric machine 50 having a simple stator winding is an inverter circuit 150. Electric machine 50 is intended in this example to be configured as a three-phase electric machine 50. Inverter circuit 150 is used to rectify a multiphase current, in this example, a three-phase current which is provided by electric machine 100 during a generator operation. In addition, inverter circuit 150 makes it possible to convert a rectified current into a three-phase current in order to operate electric machine 50 in a motor mode.

During the generator operation of electric machine 50, inverter circuit 150 provides a first subsystem d.c. voltage of, for example, 48 V for a first subsystem N₁ of the motor vehicle electrical system. With the aid of this first subsystem d.c. voltage, it is possible to operate multiple electrical consumers, which are represented symbolically in FIG. 1a and designated as V₁ and V₂. Such an electrical consumer may, for example, be an electric drive of the hybrid vehicle or an energy store represented as V₂.

Since most electrical consumers in the hybrid vehicle, such as a starter motor of an internal combustion engine, a car radio or an on-board computer are operated with a lower voltage than the first subsystem d.c. voltage, the first subsystem d.c. voltage is reduced by a DC-DC converter to a second subsystem d.c. voltage, for example, 14 V, for a second subsystem N₂. Electrical consumers which are operated with the second d.c. voltage are represented symbolically in FIG. 1 and designated as V₃, V₄ and V₅.

The voltage levels 48 V and 14 V used are merely examples. The present invention may also be used in conjunction with other voltages or voltages varying over time.

FIG. 2 schematically shows one specific embodiment of a multi-voltage vehicle electrical system having an energy supply unit 1, which is configured to carry out one specific embodiment of a method according to the present invention. Connected downstream from an electric machine 100 having a double stator winding are two converter circuits 200. Converter circuits 200 serve both as inverter circuits for supplying a first subsystem N₁ with a first subsystem d.c. voltage U₁, for example 48 V, via which the electrical consumers V₁ and V₂ are operated, and for supplying a second subsystem N₂ having a second subsystem d.c. voltage U₂, for example 12 V, via which the consumers V₃, V₄ V₅ are operated. Energy supply unit 1 makes it possible in a first operating mode to transfer electrical power between the two subsystems N₁ and N₂, to transfer in a second generator operation electrical power from electric machine 100 to subsystem N₁ and/or N₂ and, in a third motor operation, to transfer electrical power from first motor vehicle electrical system N₁ to electric machine 100 and, if necessary, also to second motor vehicle electrical system N₂.

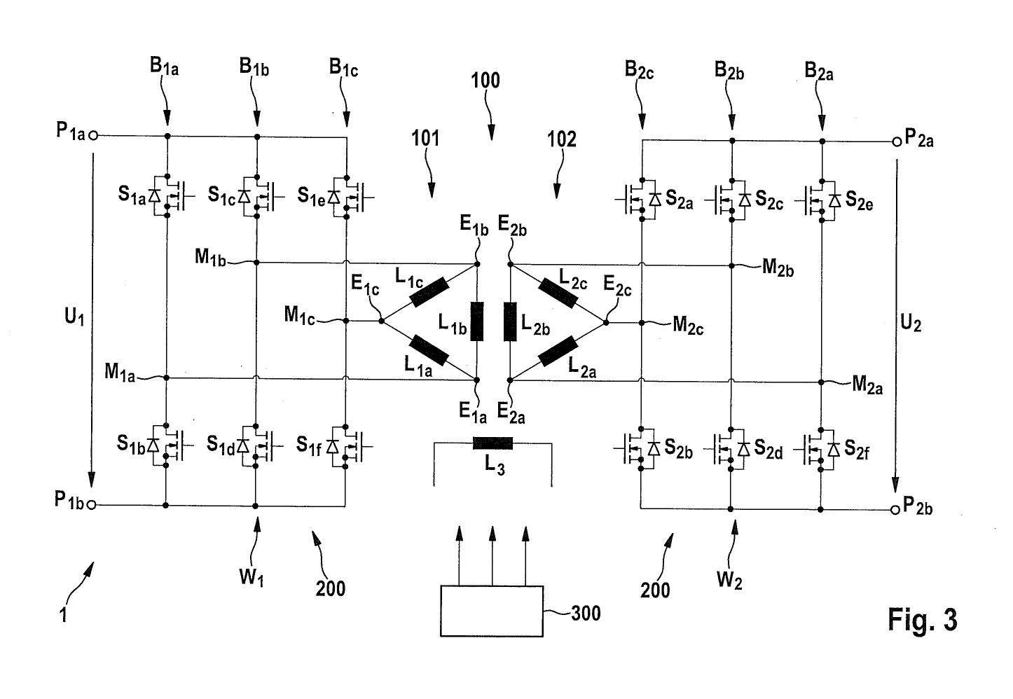

Energy supply unit 1 and a specific embodiment of a method according to the present invention for operating energy supply unit 1 are described with reference to FIG. 3.

Electric machine 100 in this example is configured as a three-phase electric machine. Electric machine 100 includes a first stator winding 101 and a second stator winding 102. Each of stator windings 101 and 102 includes three stator inductances or phases L₁ₐ, L_{1b}, L_{1c} and L₂ₐ, L_{2b}, L_{2c}. The stator inductances of stator windings 101 and 102 are each connected to a delta circuit. Electric machine 100 further includes an excitation winding L₃.

First stator winding 101 and second stator winding 102 are each connected to a converter circuit W₁ and a second converter circuit W₂. The two converter circuits W₁ and W₂ as a whole are labeled with reference numeral 200. First converter circuit W₁ is connected to terminals P₁ₐ and P_{1b} of first subsystem N₁, between which first subsystem d.c. voltage U₁ is applied. Second converter circuit W₂ is connected to terminals P₂ₐ and P_{2b} of second subsystem N₂, between which second subsystem d.c. voltage U₂ is applied.

Converter circuits W₁ and W₂ are configured, in particular, analogously to an inverter circuit 150 according to the related art. In this configuration, each of converter circuits W₁ and W₂ includes in each case three half bridges B₁ₐ, B_{1b}, B_{1c} and B₂ₐ, B_{2b}, B_{2c}. Each of the half bridges includes two switches S₁ₐ through S_{1f} and S₂ₐ through S_{2f}, which in this example are configured as MOSFETs. Each of half bridges B₁ₐ, B_{1b} and B_{1c} of first converter circuit W₁ is connected in each case via a center tap M₁ₐ, M_{1b} and M_{1c} to a phase connection E₁ₐ, E_{1b} and E_{1c} of first stator winding 101. The same applies to center taps M₂ₐ, M_{2b} and M_{2c} of second converter circuit W₂ and phase connections E₂ₐ, E_{2b} and E_{2c} of second stator winding 102.

Shown in addition to energy supply unit 1 is a processor unit which is configured, in particular, as a control unit 300 of the vehicle, which is programmed to carry out a specific embodiment of a method according to the present invention. Control unit 300 controls the activation of electric machine 100 and converter circuits W₁ and W₂ in general and of the individual parts and the switching of individual switches S₁ₐ to S_{1f} and S₂ₐ to S_{2f} in particular.

In a transformational operating mode (first operating mode), electrical power is transferred between first subsystem N₁ and second subsystem N₂ via first and second converter circuits W₁ and W₂ and via first and second stator windings 101 and 102.

Described by way of example below is the transfer of electrical power from first subsystem N₁ to second subsystem N₂. The same applies to the transfer of electrical power in the other direction. First subsystem d.c. voltage U₁ of first subsystem N₁ is converted into a three-phase a.c. voltage operated with the aid of first converter circuit W₁ which is operated or activated as an inverter. For this purpose control unit 300 advantageously activates switches S₁ₐ through S_{1f} of first converter circuit W₁. This three-phase a.c. voltage generates a current flow in first stator winding 101, which in turn induces a three-phase a.c. voltage in second stator winding 102. This induced three-phase a.c. voltage is rectified with the aid of second converter circuit W₂, which is activated as a rectifier, and fed into second subsystem N₂. For this purpose control unit 300 advantageously activates switches S₂ₐ through S_{2f} of second converter circuit W₂. The clocked, advantageous activation of the individual switches of converter circuits W₁ and W₂ enables second subsystem d.c. voltage U₂ to be adjusted.

An excitation current of the excitation winding L₃ of electric machine 100 is advantageously equal to zero so that no synchronous generated voltage is induced in stator windings 101 and 102. The transfer of electrical energy may be carried out in conjunction with rotating as well as with stationary electric machine 100.

In the second generator operating mode, mechanical power is converted into electrical power and, depending on the need, delivered to first subsystem N₁ with first subsystem d.c. voltage U₁ and/or to second subsystem N₂ with second subsystem d.c. voltage U₂. The level of these two transferred electrical powers is regulated by activating switches S₁ₐ through S_{1f} of first converter circuit W₁ and switches S₂ₐ through S_{2f} of second converter circuit W₂, as well as the current through excitation winding L₃.

In the third motor operating mode, the phases of electric machine 100 are energized with the aid of clocked advantageous switching of switches S₁ₐ through S_{1f} of first converter circuit W₁, as a result of which electrical power from first subsystem N₁ is converted into mechanical power. The level of converted electrical power may be adjusted by such activation of switches S₁ₐ through S_{1f}.

Depending on the need, switches S₂ₐ through S_{2f} of second converter circuit W₂ are activated in such a way that in addition to the conversion of electrical power into mechanical power, electrical power is likewise transferred from first subsystem N₁ into second subsystem N₂. The level of this transferred power is regulated by the activation of switches S₂ₐ through S_{2f} of second converter circuit W₂. Alternatively, switches S₂ₐ through S_{2f} may also be activated in such a way that no electrical power is transferred from first subsystem N₁ into second subsystem N₂.

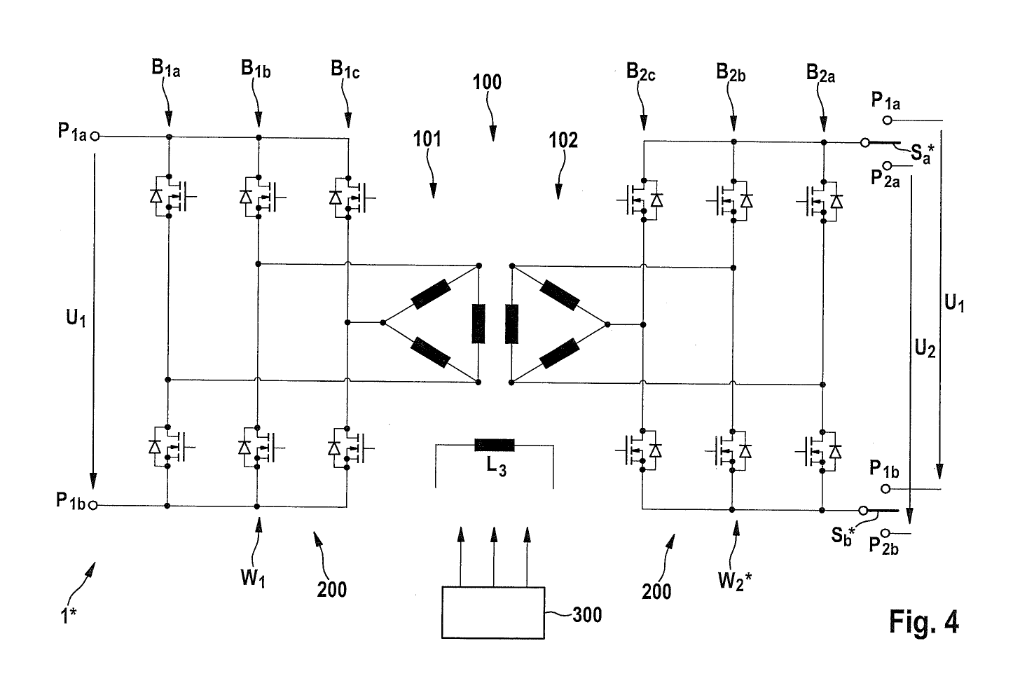

FIG. 4 shows in a circuit diagram-like manner another embodiment of an energy supply unit 1* which is configured to carry out another specific embodiment of a method according to the present invention. Energy supply unit 1* from FIG. 4 is similar in configuration to energy supply unit 1 from FIG. 3. For the sake of clarity, therefore, not all reference numerals are shown again in FIG. 4.

Energy supply unit 1* from FIG. 4 differs from energy supply unit 1 from FIG. 3 by converter circuit W₂*. The half bridges B₂ₐ, B_{2b}, B_{2c} of energy supply unit 1* are configured identically to those of energy supply unit 1. Converter circuit W₂*, however, includes two switch elements Sₐ* and S_{b}* which are activated by control unit 300. With the aid of these switch elements Sₐ* and S_{b}* converter circuit W₂* may be connected either to terminals P₂ₐ and P_{2b} of second subsystem N₂ or to terminals P₁ₐ and P_{1b} of first subsystem N₁.

If converter circuit W₂* is connected to first motor vehicle electrical system N₁, a maximum transferrable electrical power may be converted in the motor and in the generator operation mode.

If converter circuit W₂* is connected to second motor vehicle electrical system N₂, energy supply unit 1* is activated similar to FIG. 3.

What is claimed is:

1. A method for operating an energy supply unit for a motor vehicle electrical system including at least one first subsystem and one second subsystem having different voltage levels, the method comprising:
connecting one first stator winding of an electric machine via a first converter circuit to the first subsystem, and connecting one second stator winding of the electric machine via a second converter circuit to the second subsystem; and
providing a DC-DC conversion between the first subsystem and the second subsystem, wherein one of the converter circuits is operated as an inverter and the other converter circuit is operated as a rectifier, and wherein the first stator winding and the second stator winding are operated as a transformer.

2. The method of claim 1, wherein electrical power is transferred between the first subsystem and the second subsystem via the first converter circuit and the second converter circuit and via the first stator winding and the second stator winding.

3. The method of claim 1, wherein the first converter circuit and the second converter circuit are each operated as a step-down converter and/or as a step-up converter.

4. The method of claim 1, wherein in a second operating mode the converter circuits are operated as a rectifier and the electric machine is operated as a generator.

5. The method of claim 4, wherein in the second operating mode electrical power is transferred from the electric machine into at least one of the first subsystem and into the second subsystem.

6. The method of claim 1, wherein in a third operating mode the converter circuits are operated as an inverter and the electric machine is operated as a motor.

7. The method of claim 6, wherein in the third operating mode either electrical power is transferred from the first subsystem into the electric machine or electrical power is transferred from the first subsystem into the electric machine and into the second subsystem.

8. The method of claim 1, wherein the first converter circuit and the second converter circuit are operated so that the transferred electrical powers are adjustable separately from one another.

9. The method of claim 1, wherein the second converter circuit is connected either to the second subsystem or to the first subsystem.

10. A processor unit for operating an energy supply unit for a motor vehicle electrical system including at least one first subsystem and one second subsystem having different voltage levels, comprising:
a processor arrangement for performing the following:
connecting one first stator winding of an electric machine via a first converter circuit to the first subsystem, and connecting one second stator winding of the electric machine via a second converter circuit to the second subsystem; and
providing a DC-DC conversion between the first subsystem and the second subsystem, wherein one of the converter circuits is operated as an inverter and the other converter circuit is operated as a rectifier, and wherein the first stator winding and the second stator winding are operated as a transformer.

11. A computer readable medium having a computer program, which is executable by a processor, comprising:
a program code arrangement having program code for operating an energy supply unit for a motor vehicle electrical system including at least one first subsystem and one second subsystem having different voltage levels, by performing the following:
connecting one first stator winding of an electric machine via a first converter circuit to the first subsystem, and connecting one second stator winding of the electric machine via a second converter circuit to the second subsystem; and
providing a DC-DC conversion between the first subsystem and the second subsystem, wherein one of the converter circuits is operated as an inverter and the other converter circuit is operated as a rectifier, and wherein the first stator winding and the second stator winding are operated as a transformer.

12. The computer readable medium of claim 11, wherein electrical power is transferred between the first subsystem and the second subsystem via the first converter circuit and the second converter circuit and via the first stator winding and the second stator winding.
